(19) United States
(12) Patent Application Publication
(10) Pub. No.: US 2016/0364541 A1
(43) Pub. Date: Dec. 15, 2016

(54) System and Method of Automated Access into a Telehealth Network

(71) Applicant: Wellspring Telehealth, LLC, Bryan, TX (US)

(72) Inventors: Menville B. Flippen, College Station, TX (US); Robert Peyton Reaves, Fort Worth, TX (US)

(73) Assignee: Wellspring Telehealth, LLC, Bryan, TX (US)

(21) Appl. No.: 15/176,900

(22) Filed: Jun. 8, 2016

Related U.S. Application Data
(60) Provisional application No. 62/174,893, filed on Jun. 12, 2015.

(51) Int. Cl. G06F 19/00; H04L 29/08

(52) U.S. Cl. CPC G06F 19/3418; G06F 19/322; H04L 67/306

(57) ABSTRACT

The present invention is directed to a system for controlling access for a telehealth network, wherein the controlled access is automatic and intermittent. A trigger enables access to the telehealth network. A second trigger disables access to the telehealth network.

### CROSS REFERENCES TO RELATED APPLICATIONS

This application claims the benefit of U.S. Provisional Application No. 62/174,893, filed Jun. 12, 2015, which is incorporated herein by reference in its entirety.

### BACKGROUND OF THE INVENTION

1. Field of the Invention

The present invention is generally directed to automated access to a telehealth network, and more particularly, to providing integrative medical, wellness, and behavioral analysis within the telehealth network.

2. Description of the Prior Art

Generally, telemedicine is the remote diagnosis and treatment of patients by means of telecommunications technology. This technology has been realized for primary care and specialist services, remote patient monitoring, consumer medical and health information, and medical education. Mechanisms for these services include devices capable of capturing diagnostic images and vital signs, such as blood glucose and electrocardiograms, and transmitting them to a physician provider or central data storage; this classic example of telemedicine is shown in PRIOR ART FIG. 1. Together, this technology can reach numerous outlying clinics, community centers, and individual patients, and provides improved healthcare access, reduced cost, and better quality. A major benefit to telehealth technology is the reduction in travel to and wait-times at clinics. Further, this convenience in healthcare may extend to patients who are traveling so they may connect instantly with a network of physicians for information, advice, and treatment, including prescription medication, when appropriate.

More recently, efforts have been made to provide more than pharmaceutical-based prescription treatment using telehealth networks. The telehealth technology can accept and communicate patient-specific data, such as health history, diet, exercise, medicine, and stress. With a whole-person perspective, telehealth technology can now monitor a patient, analyze his/her data, and consult or guide the patient on complete wellness. This style of complete and individualized healthcare is increasingly demanded.

U.S. Pat. No. 7,310,734 for method and system for securing a computer network and personal identification device by inventors Boate and Reed filed Feb. 1, 2001 and issued Dec. 18, 2007 discusses an improved computer network security system and a personal identifier device used for controlling network with real time authentication of both a person's identity and presence at a computer workstation is provided. A new user is registered to a portable personal digital identifier device and, within the portable personal digital identifier device, an input biometric of the user is received and a master template is derived therefrom and securely maintained in storage. A private key and public key encryption system is utilized to authenticate a user registered to the portable personal digital identifier device. The personal digital identifier device verifies the origin of a digitally signed challenge message from the network security manager component. A digitally and biometrically signed challenge response message is produced and transmitted by the personal digital identifier device in response to the verified challenge message.

U.S. Pat. Nos. 7,315,825 and 7,395,216 for using predictive models to continuously update a treatment plan for a patient in a healthcare location by inventors Rosenfeld and Breslow are directed to a system for determining a treatment plan for a patient comprises a database of patient data elements indicative of a medical condition associated with a patient. A predictive model is applied to patient assessment data and used to prepare a treatment plan. A rules engine applies a patient rule consistent with the treatment plan to selected data elements stored in the database to produce an output indicative of a change in the medical condition of the patient. The output from the rules engine is used to determine if intervention is warranted. The predictive model is applied continuously to determine whether to update the treatment plan and, if necessary, the patient rule.

U.S. Pat. Nos. 7,624,028 and 7,853,455 for remote health monitoring and maintenance system by inventor Brown are directed to a system and method that enables a health care provider to monitor and manage a health condition of a patient. The system includes a health care provider apparatus operated by a health care provider and a remotely programmable patient apparatus that is operated by a patient. The health care provider develops a script program using the health care provider apparatus and then sends the script program to a remotely programmable patient apparatus through a communication network such as the World Wide Web. The script program is a computer-executable patient protocol that provides information to the patient about the patient's health condition and that interactively monitors the patient health condition by asking the patient questions and by receiving answers to those questions.

U.S. Pat. No. 7,684,999 for user-based health monitoring by inventor Brown filed Dec. 3, 2004 and issued Mar. 23, 2010 discusses a user-based monitoring system that includes a remote user-based subsystem with at least one display and at least two microprocessor-based units in communication with each other. The subsystem is configured to facilitate collection of user-related data. The system also has at least one central server remotely located from and configured for two-way communication with the user-based subsystem so that it can receive and deliver signal communications to and from the user-based subsystem. The system is suited, amongst others, for monitoring remotely the health of a system user.

U.S. Pat. No. 7,818,183 for connecting consumers with service providers by inventor Schoenberg filed Oct. 22, 2008 and issued Oct. 19, 2010 is directed to a computerized system that provides information and services to the consumers in addition to connecting them with providers. The computerized system includes an access control facility, which manages and controls whether a given consumer may access the system and what level or scope of access to the features, functions, and services the system will provide.

U.S. Pat. No. 7,827,040 for patient-control of health related data in a remote patient monitoring system by inventor Brown filed Sep. 16, 2003 and issued Nov. 2, 2010 is directed to a networked health-monitoring system for collecting and processing patient health-related data. A plurality of remote patient sites each includes at least one display, a data management unit configured to facilitate collection of patient health-related data, a memory, and stored program instructions for generating health-monitoring related information on the display.

U.S. Pat. No. 7,953,613 for a health maintenance system by inventor Gizewski filed Jan. 3, 2007 and issued May 31, 2011 discusses a health maintenance system for comprehensive health assessment, abnormality detection, health monitoring, health pattern and trend detection, health strategy development, and health history archiving. The health maintenance system comprises a subscriber segment and a system segment, communicatively coupled.

U.S. Pat. No. 7,970,620 for multi-user remote health monitoring system with biometrics support by inventor Brown filed Aug. 30, 2002 and issued Jun. 28, 2011 is directed to a networked system for identifying an individual, communicating information to the individual, and remotely monitoring the individual. The system includes a remotely programmable apparatus that occasionally connects to a server via a communication network such as the Internet. The remotely programmable apparatus interacts with the individual in accordance with a script program received from the server. Among other capabilities, the script program may instruct the remotely programmable apparatus to identify the individual, to communicate information to the individual, to communicate queries to the individual, to receive responses to the queries, and to transmit information identifying the individual and the responses from the remotely programmable apparatus to the server.

U.S. Pat. No. 7,970,633 for system and method for delivering medical examination, treatment and assistance over a network by inventor Bulat filed Nov. 18, 2008 and issued Jun. 28, 2011 is directed to a system for delivering medical examination, diagnosis, and treatment services from a health care practitioner to a patient over a network includes a plurality of health care practitioner terminals and a plurality of patient terminals in audiovisual communication over the network with any of the plurality of health care practitioner terminals. Each of the plurality of health care practitioner terminals includes a display device. The system also includes a call center in communication with the patient terminals and the health care practitioner terminals. The call center routs a call from a patient at one of the patient terminals to an available health care practitioner at one of the health care practitioner terminals so that the available health care practitioner may carry on a two-way conversation with the patient and visually observe the patient. The available health care practitioner may make an assessment of the patient and treat the patient.

U.S. Pat. No. 8,249,894 for networked remote patient monitoring with handheld devices by inventor Brown filed Sep. 16, 2003 and issued Aug. 21, 2012 is directed to a networked health-monitoring system is configured to collect and process patient health-related data. The system includes at least one handheld microprocessor device having a display; and a memory. At least one central server is connected to receive health-related data communicated to the handheld microprocessor device and at least one remotely located health care professional computer is in signal communication with the central server. It receives patient health-related information based on the patient health-related data received from the handheld microprocessor device. The system is configured to convert the handheld microprocessor device into a healthcare monitoring device that functions to monitor patient health conditions and communicate data related to the monitored conditions to the central server.

U.S. Pat. No. 8,788,715 for network and interface selection on a computing device capable of establishing connections via multiple network communications media by inventors Krantz, et al. filed Jul. 22, 2011 and issued Jul. 22, 2014 is directed to a system and method for carrying out network and interface selections across multiple media is disclosed, wherein the disclosed system facilitates automated network interface configuration decision-making that spans a set of networks supporting communications via differing media.

US patent application 2010/094659 for consolidation of consumer interactions within a medical brokerage system by inventor Schoenberg filed Dec. 15, 2009 and issued Apr. 15, 2010 discusses a health improvement function to assess a consumer patient's current overall health and wellness state, a specific area of the health and wellness state, or treatment for a specific condition, issue or symptom. A profiling operation is performed using the data collected by the intake stage to form a profile of the patient. These data include the consumer's goals, where the consumer wants the consumer's health state to be in the future, and desired changes in the consumer's overall health and wellness state or in a specific area of the consumer's health and wellness state (e.g., body weight, BMI, cholesterol level, etc.), or treatment for a specific condition, issue or symptom.

Regarding telehealth technology, the prior art is directed to incentives that reward favorable health, interfacing with external data sources to acquire information from available systems automatically to use the information to prepare providers at the beginning of an engagement, consumer profiles and analytics of consumer data, and secured access into a network or management of data files in a network.

The prior art is limited regarding patient actions automatically generated by forecasting algorithms based on a patient's patterns, integrating a patient's information with the patient's profile to generate patient patterns, and analysis that is automated. Further, automated, intermittent, controlled access to a telehealth network has not been realized. The development of such a telehealth network will allow for a more complete and convenient healthcare.

### SUMMARY OF THE INVENTION

The present invention is directed to a system for controlling access into and out of a telehealth network, wherein the controlled access is automatic and intermittent.

These and other aspects of the present invention will become apparent to those skilled in the art after a reading of the following description of the preferred embodiment when considered with the drawings, as they support the claimed invention.

### BRIEF DESCRIPTION OF THE DRAWINGS

PRIOR ART FIG. 1. A schematic diagram of a typical telehealth network communication between a patient device and network.

FIG. 2. A schematic diagram of communication lines for a telehealth network of the present invention.

FIG. 3. A flow diagram illustrating steps in methods of the present invention.

FIG. 4. A schematic diagram illustrating a general cloud-based computer system.

### DETAILED DESCRIPTION

The present invention provides a system for automated, intermittent or occurring occasionally or at regular or irregular intervals or periodic access to a telehealth network, wherein the telehealth network provides automated, integrative analysis of a patient's health history, including diet, exercise, and behavior.

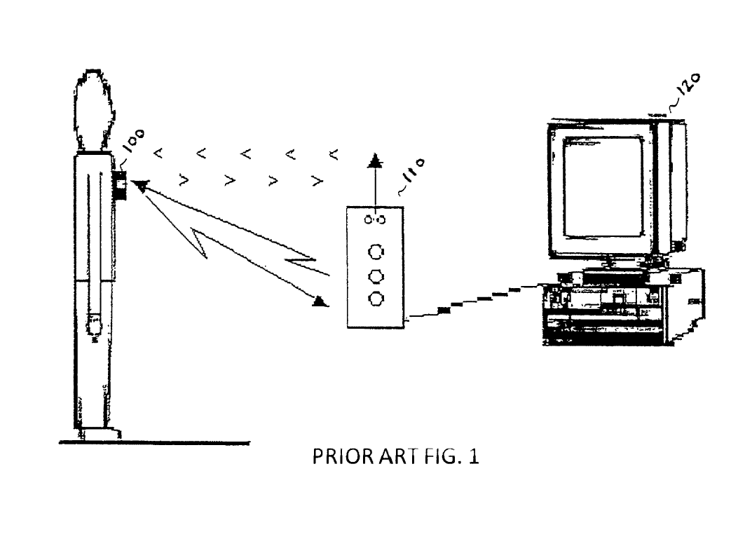

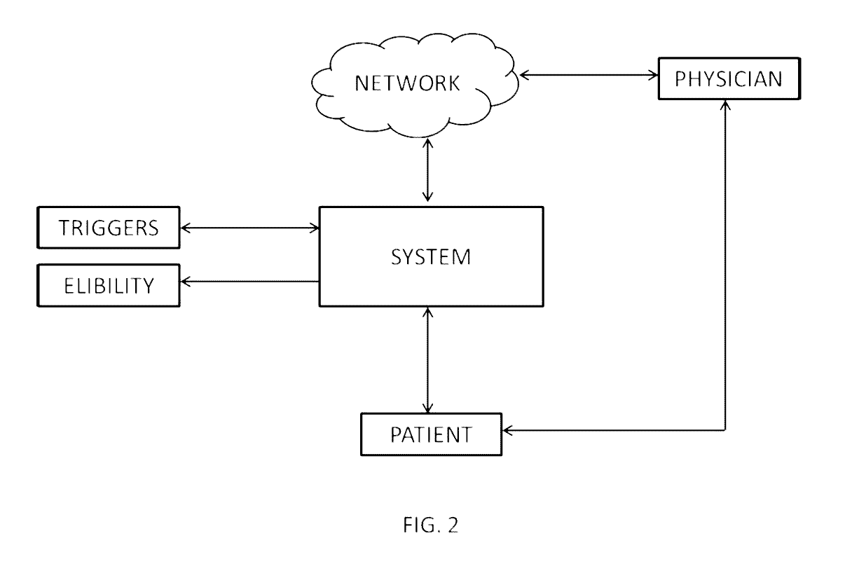

In a preferred embodiment of the present invention, the system provides access to a patient automated, controlled access to a telehealth network. FIG. 2 illustrates system configuration for an embodiment of the present invention. A user or patient directly or indirectly requests access to the system that controls entry into the telehealth network. The system checks the user or patient's eligibility or fulfillment of pre-requisites to be admitted into the telehealth network. Approval into the system (i.e., pre-requisite fulfillment and/or registration) requires inputs of patient identification and information, such as, by way of example and not limitation, a unique identification number, ticket purchase, or group association. System eligibility confirmation is followed by patient verification, wherein the patient inputs more specific identifiable information, such as a unique identification number, via a website, mobile application (App), or phone call. Preferably, verification is made through a mobile communication device, which later may be used as a location device and data transceiver. Patient verification confers to the system the ability to access the patient's health history when the patient is granted access to the telehealth network. After the system admittance pre-requisites are fulfilled and the patient is verified but before the patient is allowed into the telehealth network, the patient may be placed in a pre-activation status or holding period. This time period is referred to as dormant because the system has confirmed that the patient will be allowed access to the telehealth network, but the user or patient has not been activated completely into the network. Finally, activation of patient access into the telehealth network is initiated by at least one automated activation trigger.

Preferably, the system includes a server and a patient communications device. In another embodiment, the system also includes a measurement device for measuring and/or communicating biometric data in real-time or near real-time.

In preferred embodiments of the present invention, unique identifiers typically include at least two of the following components: first name; last name; date of birth; unique identification identifier, code, or number; phone number; email address. Furthermore, the unique identification identifier, code, or number may be selected from the group consisting essentially of: a member number or ID, a rewards or loyalty number or ID, a health plan ID, a company ID, a ticket number, a confirmation number, a member ID and date of membership activation combination, and combinations thereof.

The activation access is controlled by at least one automated trigger. For example and not limitation, the at least one trigger for activation to the network may include a ticket purchase, check-in time, departure or arrival time, or employment hiring date, whereas the at least one trigger for de-activation or termination of access include check-out time, departure or arrival time, or employment termination date. Together, the controlled access afforded by the at least one trigger provides automatic, intermittent access to the patient. Preferably, the trigger for activation is not merely the patient entering information or filling out a form. The trigger for activation or de-activation is preferably the occurrence of an event or passage of time. In one embodiment, the occurrence of a trigger is detected by a non-generic computing device such as a GPS device detecting an airplane leaving an airport or arriving at an airport or any other type of transportation (train, vehicle, car, truck, boat, helicopter, etc.) leaving a departure point or arriving at a destination, a bar code reader, a QR code reader, or any other code reader reading a ticket or code corresponding to check-in, check-out, departure, or arrival, a card reader determining a payment card has been read at the card reader via NFC, RFID, magnetic card swipe, or any other card number entry which coincides with lodging check-in or check-out.

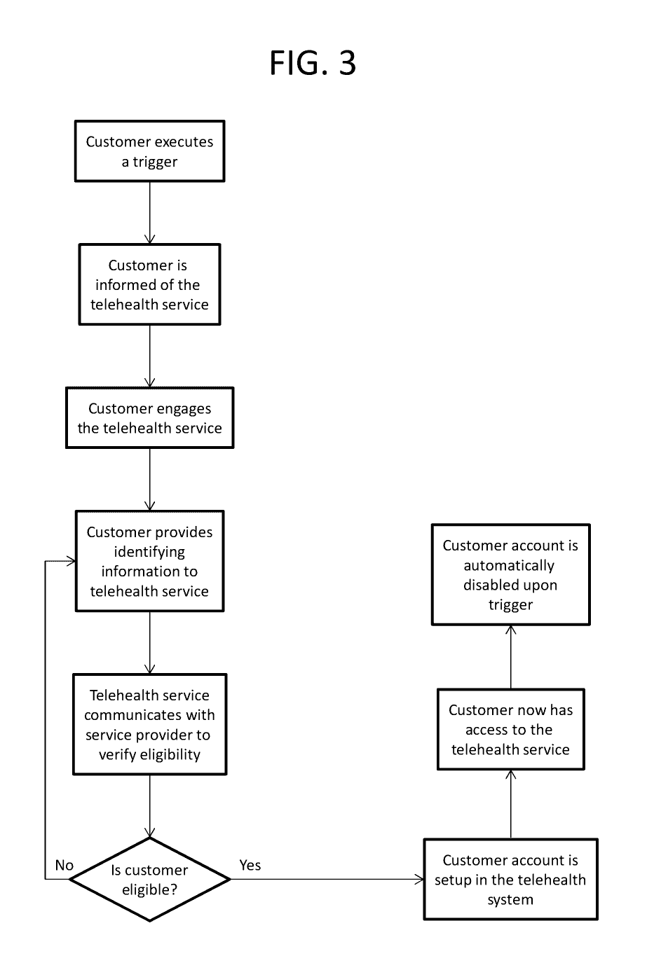

Another embodiment includes short-term eligibility as displayed in FIG. 3, wherein the patient provides at least one identifying pieces of information to verify his or her eligibility for service. Examples of information include a name along with a reservation or ticket number, a mobile phone number, e-mail address etc. A benefit to the e-mail or SMS is that the patient's mobile number or email address could be used as the identifier as opposed to names or reservations numbers, making transaction between parties easier and more efficient, and risk of sharing potentially sensitive information, such as ticket numbers, reservations, etc., would be significantly reduced. The system administrator or agent thereof (WellVia) contacts the service provider (airline, hotel, etc.) and request eligibility dates attached to the customer. Eligibility dates would be a check-in, check-out date, travel date, etc. If the patient is within the eligible window, the patient's account would automatically be setup and he or she would have access to the service for the dates provided from the service provider. The account would automatically close when the eligibility date lapses.

The patient can learn of the system administrator based upon the agreement between service provider and system administrator. By way of example and not limitation, system administrator information could be provided by the service provider to the patient upon ticket purchase, check-in, etc., or the system administrator could be notified of a pre-determined trigger and automatically send the patient information via email or mobile messaging. A separate mobile app, website, etc. for each service provider can make the process easier on the patient, since each service provider may request different pieces of information for eligibility verification. By way of example and not limitation, when a patient looks for the mobile app he or she may see two apps—one called “System Administrator” and one called “System Administrator—Hilton Guests”. The “Hilton Guests” app applies to those patients staying at a Hilton hotel. This method would enable some co-branding of the app if the service provider desired this. The downside to separated apps would be the added confusion. Regardless, the standalone “System Administrator” app will be able to support typical customers and partnering service providers. When the patient accesses the System Administrator through one of the above methods, he or she will be asked for the unique identifiers that have been worked out with the service provider for eligibility to be verified.

A preferred embodiment of the present invention is access to a telehealth network for a patient who is traveling with an airline. As an airline member, when the patient purchases a ticket, the system automatically provides eligibility to the patient to join the telehealth network; the patient has fulfilled a pre-requisite for system admittance, namely membership. At this point, the patient traveler is placed in a dormant or holding phase preceding access into the telehealth network. Upon check-in for the initial flight's departure, the patient is provided access by the system into the telehealth network. In another embodiment, an established time period before check-in would act as the at least one trigger for activation. In an alternative embodiment, flight departure time would be the at least one trigger for activation. The patient would be released from the network by at least one trigger for de-activation, such as check-in for or departure of return flight.

In another embodiment, as a hotel club member, when the patient reserves a hotel room, the system automatically provides eligibility to the patient to join the telehealth network. At this point, the patient is placed in a dormant phase preceding full access by the system into the telehealth network. Upon hotel check-in—the at least one trigger for activation, the patient is automatically provided access by the system into the telehealth network. In another embodiment, when the user/patient enters within the range of the hotel's wireless internet signal for the first time following an initial trigger such as, by way of example and not limitation, user accessing WellVia website or mobile App for confirming registration with the system, the user/patient is automatically received into the telehealth network. Preferably, the mobile communication device used by the user/patient for patient verification will communicate with the hotel's wireless internet signal to connect to the telehealth network. The patient is released from the network by a de-activation trigger, such as hotel check-out.

In an alternative embodiment, a patient may purchase access to the system using membership rewards or airline miles, for example. In yet another embodiment, a patient may purchase access into the system with personal money, and following patient verification, the patient is granted access into the telehealth network. De-activation of network access would be triggered by a form of missed payment or the patient's permission to withdraw, for example.

Inside the telehealth network, the system delivers medical examination, diagnosis, and treatment services from a health care practitioner to the patient, including a plurality of health care practitioner terminals and a plurality of patient terminals in audiovisual communication over the network with any of the plurality of health care practitioner terminals as discussed in U.S. Pat. No. 7,970,633, which is hereby incorporated by reference in its entirety. A physician can access the network to obtain raw and/or analyzed patient health records. The physician and patient may communicate about the records or other medical and/or wellness information. This type of remote communication is especially convenient for a patient who may be traveling.

In addition to medical services, the telehealth network integrates and cross communicates between variable components of a patient's health, including, for example and not limitation, medical, wellness, and behavioral. The cross communication is possible via a cloud-based system, wherein data sharing and restriction follows HIPAA regulations. A patient's health variables are analyzed to provide an integrative view of the patient's health history, which then may be communicated to the patient via the patient's portable devices.

The telehealth network analysis may create a profile for the patient based on the patient's health history, wherein the profile reflects the patient's patterns. Preferably, the complete patient profile includes health history components, such as current medication and dosage, past medication and dosage, past therapy, current therapy, past injury, current injury, past surgeries, scheduled surgeries, past appointments, scheduled appointments, genetic predispositions to conditions, illness, diet, allergies, fitness, health insurance information, and/or exercise and/or sports history, wherein details of these components include dates, frequencies, and dosages. Using these profile components, the network may forecast the patient's patterns and/or projected measurements of the patient, and when the patient's actions and/or projected measurements do not correlate with the profile forecast, the system may communicate with the patient. Communication involves emails, texts, phone calls, and/or other notifications to a communications device of the patient and/or a measurement device of the patient. In an alternative embodiment, communication involves emails, texts, phone calls, and/or other notifications to a health care provider, an emergency contact, a family member, and/or a caretaker of the patient. In yet another embodiment, communication involves phone calls to an ambulance, 911, or other emergency service.

The communication will serve as a source of health accountability to improve compliance and adherence to ongoing medical, exercise, and/or dietary therapies. The network profile may identify risks and provide recommendations to the patient to augment risk reduction. When risks have been reduced, the system may provide rewards and incentives to encourage healthy behavior patterns.

In another embodiment, the profile integrates previous lab metrics and physician appointment dates to provide pro-active follow-up. Messages will be sent to the patient for routine or non-routine physician appointment reminders.

In an alternative embodiment, the patient wears a device that tracks the patient's exercise and sleep habits. In another embodiment, the patient uses or wears a device which includes one or more biosensors operable to measure and monitor biological and/or physiological outputs. By way of example and not limitation, these devices with biosensors include measurement devices for measuring blood pressure, vision quality, pressure in the eyes, changes in pressure in the eyes, body temperature, temperatures of extremities, blood glucose, blood sugar, hydration, heart rate, sweat rate, sweat content, breathing rate, breathing volume, calories burned, number of whole and/or partial sleep cycles, length of sleep cycles, steps taken, medication taken from a container, medication taken in the human body (by way of example, by measuring the products of a reaction between the human body and the medication), an amount and duration of therapy from devices such as pain relieving devices which use infrared light therapy for pain relief, amounts of medication remaining such as the “puffs” left in an albuterol inhaler, detection of air quality, electrodermal response EDR, tremors for Parkinson's patients, speed of movement, posture, force of impact from physical sports, arrhythmia detection, epilepsy monitoring, stress monitoring, alpha wave monitoring, beta wave monitoring, pulse, blood oxygen saturation, lung function, standing time, exercise time, body mass index (BMI), cholesterol level, weight, etc. Preferably the measurement device is a non-generic computing device. Preferably, the measurements from these devices with biosensors are added to the profile of the patient. Preferably, the profile of the patient also includes past measurements from these devices and/or projected future measurements or ranges of measurements from these devices. If the measurement is not within a projected future range of measurements or equal to a projected future measurement, the server is operable to provide a target measurement and communicate that target measurement to the communications device and/or the measurement device of the patient. In one embodiment, the target measurement includes a target time frame. In another embodiment, the target measurement includes recommendations for achieving the target measurement. In yet another embodiment, one or more incentives are associated with achieving the target measurement.

The device communicates with the network profile to moderate forecast analysis. Similarly, the patient uses an app on his/her mobile communication device to input dietary habits, such as for example and not limitation, what, when, and where food was consumed. The device prompts the patient to enter the data, which increases adherence, and communicates this information with the network profile to moderate forecast analysis.

Security in the network including access restriction to authorized or authenticated users is provided by a combination of the user/patient registering with specific identifier(s) with WellVia via the network, and the validation or authentication thereof with the service provider (e.g., airline, hotel, etc.). Upon a successful validation, WellVia will create and/or enable access for a user by providing an account specific to that user. Each account will contain an ID, First Name, Last Name, and Date of Birth for identification. These items are required to access the telehealth network and are provided by the patient. This account can be accessed by a username/email and a password specified by the user. Physical and Technical security is multifaceted. WellVia relies on its own security measures as well as our strategic and technical partnerships (datacenters, telecommunication providers, etc.) to require and enforce compliance with some or all but not limited to HIPAA/HITECH, ISO/IEC 27001/27002, PCI, SOC1, SOC2, SSL, functional equivalents, and combinations thereof. Any sensitive data being communicated by or to the patient is done over a secure method of transport. Preferably, data is encrypted at rest, i.e., if an unauthorized person were to remove data from the system they would not be able to access the information.

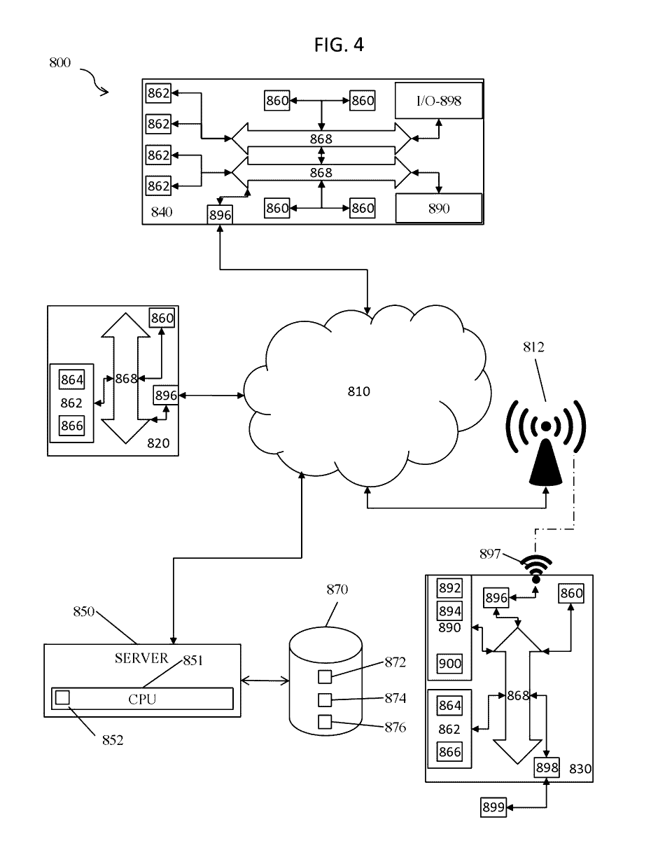

FIG. 4 is a schematic diagram of an embodiment of the invention illustrating a computer system, generally described as 800, having a network 810, a plurality of computing devices 820, 830, 840, a server 850 and a database 870.

The server 850 is constructed, configured and coupled to enable communication over a network 810 with a computing devices 820, 830, 840. The server 850 includes a processing unit 851 with an operating system 852. The operating system 852 enables the server 850 to communicate through network 810 with the remote, distributed user devices. Database 870 may house an operating system 872, memory 874, and programs 876.

In one embodiment of the invention, the system 800 includes a cloud-based network 810 for distributed communication via a wireless communication antenna 812 and processing by a plurality of mobile communication computing devices 830. In another embodiment of the invention, the system 800 is a virtualized computing system capable of executing any or all aspects of software and/or application components presented herein on the computing devices 820, 830, 840. In certain aspects, the computer system 800 may be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of digital computers 820, 840, 850 and mobile devices 830, such as a server, blade server, mainframe, mobile phone, a personal digital assistant (PDA), a smart phone, a desktop computer, a netbook computer, a tablet computer, a workstation, a laptop, and other similar computing devices. The components shown here, their connections and relationships, and their functions, are meant to be exemplary only, and are not meant to limit implementations of the invention described and/or claimed in this document

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 may additionally include components such as a storage device 890 for storing the operating system 892 and one or more application programs 894, a network interface unit 896, and/or an input/output controller 898. Each of the components may be coupled to each other through at least one bus 868. The input/output controller 898 may receive and process input from, or provide output to, a number of other devices 899, including, but not limited to, alphanumeric input devices, mice, electronic styluses, display units, touch screens, signal generation devices (e.g., speakers) or printers.

By way of example, and not limitation, the processor 860 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 4, multiple processors 860 and/or multiple buses 868 may be used, as appropriate, along with multiple memories 862 of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function.

According to various embodiments, the computer system 800 may operate in a networked environment using logical connections to local and/or remote computing devices 820, 830, 840, 850 through a network 810. A computing device 830 may connect to a network 810 through a network interface unit 896 connected to the bus 868. Computing devices may communicate communication media through wired networks, direct-wired connections or wirelessly such as acoustic, RF or infrared through an antenna 897 in communication with the network antenna 812 and the network interface unit 896, which may include digital signal processing circuitry when necessary. The network interface unit 896 may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications or other data embodying any one or more of the methodologies or functions described herein. The computer readable medium may include the memory 862, the processor 860, and/or the storage media 890 and may be a single medium or multiple media (e.g., a centralized or distributed computer system) that store the one or more sets of instructions 900. Non-transitory computer readable media includes all computer readable media, with the sole exception being a transitory, propagating signal per se. The instructions 900 may further be transmitted or received over the network 810 via the network interface unit 896 as communication media, which may include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory or other solid state memory technology, disks or discs (e.g., digital versatile disks (DVD), HD-DVD, BLU-RAY, compact disc (CD), CD-ROM, floppy disc) or other optical storage, magnetic cassettes, magnetic tape, magnetic disk storage or other magnetic storage devices, or any other medium that can be used to store the computer readable instructions and which can be accessed by the computer system 800.

It is also contemplated that the computer system 800 may not include all of the components shown in FIG. 4, may include other components that are not explicitly shown in FIG. 4, or may utilize an architecture completely different than that shown in FIG. 4. The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

By way of definition and description supporting the claimed subject matter, preferably, the present invention includes communication methodologies for transmitting data, data packets, messages or messaging via a communication layer. Wireless communications over a network are preferred. Correspondingly, and consistent with the communication methodologies for transmitting data or messaging according to the present invention, as used throughout this specification, figures and claims, wireless communication is provided by any reasonable protocol or approach, by way of example and not limitation, Bluetooth, Wi-Fi, cellular, zigbee, near field communication, and the like; the term “ZigBee” refers to any wireless communication protocol adopted by the Institute of Electronics & Electrical Engineers (IEEE) according to standard 802.15.4 or any successor standard(s), the term “Wi-Fi” refers to any communication protocol adopted by the IEEE under standard 802.11 or any successor standard(s), the term “WiMax” refers to any communication protocol adopted by the IEEE under standard 802.16 or any successor standard(s), and the term “Bluetooth” refers to any short-range communication protocol implementing IEEE standard 802.15.1 or any successor standard(s). Additionally or alternatively to WiMax, other communications protocols may be used, including but not limited to a “1G” wireless protocol such as analog wireless transmission, first generation standards based (IEEE, ITU or other recognized world communications standard), a “2G” standards based protocol such as “EDGE or CDMA 2000 also known as 1×RTT”, a 3G based standard such as “High Speed Packet Access (HSPA) or Evolution for Data Only (EVDO), any accepted 4G standard such as “IEEE, ITU standards that include WiMax, Long Term Evolution “LTE” and its derivative standards, any Ethernet solution wireless or wired, or any proprietary wireless or power line carrier standards that communicate to a client device or any controllable device that sends and receives an IP based message. The term “High Speed Packet Data Access (HSPA)” refers to any communication protocol adopted by the International Telecommunication Union (ITU) or another mobile telecommunications standards body referring to the evolution of the Global System for Mobile Communications (GSM) standard beyond its third generation Universal Mobile Telecommunications System (UMTS) protocols. The term “Long Term Evolution (LTE)” refers to any communication protocol adopted by the ITU or another mobile telecommunications standards body referring to the evolution of GSM-based networks to voice, video and data standards anticipated to be replacement protocols for HSPA. The term “Code Division Multiple Access (CDMA) Evolution Date-Optimized (EVDO) Revision A (CDMA EVDO Rev. A)” refers to the communication protocol adopted by the ITU under standard number TIA-856 Rev. A.

It will be appreciated that embodiments of the invention described herein may be comprised of one or more conventional processors and unique stored program instructions that control the one or more processors to implement, in conjunction with certain non-processor circuits, some, most, or all of the functions for the systems and methods as described herein. The non-processor circuits may include, but are not limited to, radio receivers, radio transmitters, antennas, modems, signal drivers, clock circuits, power source circuits, relays, current sensors, and user input devices. As such, these functions may be interpreted as steps of a method to distribute information and control signals between devices. Alternatively, some or all functions could be implemented by a state machine that has no stored program instructions, or in one or more application specific integrated circuits (ASICs), in which each function or some combinations of functions are implemented as custom logic. Of course, a combination of the two approaches could be used. Thus, methods and means for these functions have been described herein. Further, it is expected that one of ordinary skill in the art, notwithstanding possibly significant effort and many design choices motivated by, for example, available time, current technology, and economic considerations, when guided by the concepts and principles disclosed herein, will be readily capable of generating such software instructions, programs and integrated circuits (ICs), and appropriately arranging and functionally integrating such non-processor circuits, without undue experimentation.

The above-mentioned examples are provided to serve the purpose of clarifying the aspects of the invention and it will be apparent to one skilled in the art that they do not serve to limit the scope of the invention. By way of example and not limitation, membership may include status in an alumni association, corporation or affiliation with at least one company or organization, professional association, religious organization or entity, etc. All modifications and improvements have been deleted herein for the sake of conciseness and readability but are properly within the scope of the present invention.

What is claimed is:

1. A method for providing automated access to a telehealth network comprising:
a communications device enrolling a patient into a telehealth network by sending enrollment information to a server of the telehealth network;
the server creating a profile for the patient based on the enrollment information;
upon the server detecting an activation trigger event, automatically activating access to the telehealth network for the patient; and
upon the server detecting a de-activation trigger event, automatically terminating access to the telehealth network for the patient.

2. The method of claim 1, wherein the activation trigger event includes a ticket purchase for transportation, an arrival time for transportation, a departure time for transportation, a check-in time for transportation, a check-in time for lodging, and/or an employment hiring date.

3. The method of claim 1, wherein the deactivation trigger event includes an arrival time for transportation, a departure time for transportation, a check-in time for transportation, a check-out time for lodging, and/or an employment termination date.

4. The method of claim 1, wherein the profile for the patient includes health history components, wherein the health history components include current medication and dosage, past medication and dosage, past therapy, current therapy, past injury, current injury, past surgeries, scheduled surgeries, past appointments, scheduled appointments, genetic predispositions, illness, diet, allergies, fitness, health insurance information, and/or exercise history.

5. The method of claim 1, further comprising forecasting future measurements and/or actions of the patient using the profile for the patient.

6. The method of claim 1, further comprising:
a measurement device creating at least one measurement by measuring heart rate, calories burned, body temperature, and/or blood glucose of the patient;
the measurement device transmitting the at least one measurement to the server of the telehealth network; and
the server of the telehealth network adding the at least one measurement to the profile of the patient.

7. The method of claim 6, further comprising:
the server of the telehealth network determining if the at least one measurement is within a range of forecasted measurements and/or is equal to at least one forecasted measurement, wherein the range of forecasted measurements and/or the at least one forecasted measurement is created based on at least one past measurement; and
if the at least one measurement is not within the range of forecasted measurements and/or is not equal to the at least one forecasted measurement, the server of the telehealth network sending a notification to the communications device and/or the measurement device.

8. The method of claim 7, further comprising:
the server identifying at least one target measurement based on the at least one measurement, the at least one past measurement, the range of forecasted measurements, and/or the at least one forecasted measurement;
the measurement device creating at least one subsequent measurement by measuring heart rate, calories burned, body temperature, and/or blood glucose of the patient;
the measurement device transmitting the at least one subsequent measurement to the server of the telehealth network;
the server comparing the at least one subsequent measurement to the at least one target measurement; and
if the at least one subsequent measurement is equal to the at least one target measurement, is greater than the at least one target measurement if the at least one target measurement is a minimum measurement, or is less than the at least one target measurement if the at least one target measurement is a maximum measurement, sending a reward or a congratulatory message to the measurement device and/or to the communications device.

9. A system for providing automated access to a telehealth network comprising:
a communications device; and
a server administered by a telehealth network,
wherein the server is operable to enroll a patient into the telehealth network upon receipt of enrollment information from the communications device;
wherein the server is further operable to create a profile for the patient, wherein the profile includes the enrollment information;
wherein the server is further operable activate access to the telehealth network for the patient upon the server receiving notification or detecting an activation trigger event; and
wherein the server is further operable to de-activate access to the telehealth network for the patient upon the server receiving notification or detecting a de-activation trigger event.

10. The system of claim 9, wherein the activation trigger event includes a ticket purchase for transportation, an arrival time for transportation, a departure time for transportation, a check-in time for transportation, a check-in time for lodging, and/or an employment hiring date.

11. The system of claim 9, wherein the deactivation trigger event includes an arrival time for transportation, a departure time for transportation, a check-in time for transportation, a check-out time for lodging, and/or an employment termination date.

12. The system of claim 9, wherein the profile for the patient includes health history components, wherein the health history components include current medication and dosage, past medication and dosage, past therapy, current therapy, past injury, current injury, past surgeries, scheduled surgeries, past appointments, scheduled appointments, genetic predispositions, illness, diet, allergies, fitness, health insurance information, and/or exercise history.

13. The system of claim 9, wherein the server is further operable to forecast future measurements and/or actions of the patient using the profile for the patient.

14. The system of claim 9 further comprising a measurement device, wherein the measurement device is operable to create at least one measurement by measuring heart rate, calories burned, body temperature, and/or blood glucose of the patient;
wherein the measurement device is further operable to transmit the at least one measurement to the server of the telehealth network; and wherein the server of the telehealth network is operable to add the at least one measurement to the profile of the patient.

15. The system of claim 14, wherein, upon receipt of the at least one measurement, the server of the telehealth network is operable to determine if the at least one measurement is within a range of forecasted measurements and/or is equal to at least one forecasted measurement;
wherein the range of forecasted measurements and/or the at least one forecasted measurement is created based on at least one past measurement, and if the at least one measurement is not within the range of forecasted measurements and/or is not equal to the at least one forecasted measurement, the server of the telehealth network is operable to send a notification to the communications device and/or the measurement device.

16. The system of claim 15, wherein the server is further operable to identify at least one target measurement based on the at least one measurement, the at least one past measurement, the range of forecasted measurements, and/or the at least one forecasted measurement;
wherein the measurement device is further operable to create at least one subsequent measurement by measuring heart rate, calories burned, body temperature, and/or blood glucose of the patient;
wherein the measurement device is further operable to transmit the at least one subsequent measurement to the server of the telehealth network;
wherein the server is further operable to compare the at least one subsequent measurement to the at least one target measurement; and
if the at least one subsequent measurement is equal to the at least one target measurement, is greater than the at least one target measurement if the at least one target measurement is a minimum measurement, or is less than the at least one target measurement if the at least one target measurement is a maximum measurement, the server is further operable to send a reward or a congratulatory message to the measurement device and/or to the communications device.

17. A method for providing automated access to a telehealth network comprising:
a communications device enrolling a patient into a telehealth network by sending enrollment information to a server of the telehealth network;
the server creating a profile for the patient based on the enrollment information;
the server moving the profile for the patient into a dormant profile database;
upon the server detecting an activation trigger event, the server automatically activating access to the telehealth network for the patient by moving the profile for the patient into an active profile database; and
upon the server detecting a de-activation trigger event, the server automatically terminating access to the telehealth network for the patient,
wherein the step of the server automatically activating access to the telehealth network for the patient does not include the patient filling out a form or entering data.

18. The method of claim 17, wherein the activation trigger event is achieved by a GPS device measuring GPS coordinates of a vehicle or GPS coordinates of an aircraft, determining that the GPS coordinates of the vehicle or GPS coordinates of the aircraft are within a predetermined range of GPS coordinates, and communicating an activation message to the server.

19. The method of claim 17, wherein the de-activation trigger event is achieved by a GPS device measuring GPS coordinates of a vehicle or GPS coordinates of an aircraft, determining that the GPS coordinates of the vehicle or GPS coordinates of the aircraft are within a predetermined range of GPS coordinates, and communicating an activation message to the server.

20. The method of claim 17, further comprising:
a measurement device creating at least one measurement by measuring heart rate, calories burned, body temperature, and/or blood glucose of the patient;
the measurement device transmitting the at least one measurement to the server of the telehealth network; and
the server of the telehealth network adding the at least one measurement to the profile of the patient.
